(19) United States
(12) Patent Application Publication
(10) Pub. No.: US 2014/0025330 A1
(43) Pub. Date: Jan. 23, 2014

(54) DYNAMIC TEMPERATURE CALIBRATION

(71) Applicant: MCube, Inc., San Jose, CA (US)

(72) Inventor: Sanjay Bhandari, San Jose, CA (US)

(73) Assignee: MCube, Inc., San Jose, CA (US)

(21) Appl. No.: 13/940,199

(22) Filed: Jul. 11, 2013

Related U.S. Application Data
(60) Provisional application No. 61/670,577, filed on Jul. 11, 2012.

(51) Int. Cl. G01P 21/00

(52) U.S. Cl. CPC G01P 21/00
USPC 702/99

(57) ABSTRACT

A hand-held processor system for processing data from an integrated MEMS (Micro-Electro-Mechanical-Systems) device disposed within a hand-held computer system and methods therefor. The Dynamic Temperature Correction (DTC) process computes offset values to calibrate MEMS sensors using a single set of data measurements at an orientation without dynamic perturbation and one or more temperature data measurements, and without requiring advance knowledge of orientation of the device. Arbitrary output biases, which are known to be dominant on a single axis, can be corrected to ensure consistent performance. The DTC process provides a simple method to effectively calibrate a MEMS sensor without requiring extensive system resources. This process can be enhanced by additional estimations of sensor offsets using the set of data measurements or by use of rule-based empirical gain factors.

### CROSS-REFERENCES TO RELATED APPLICATIONS

The present application claims priority to and incorporates by reference, for all purposes, U.S. Pat. App. No. 61/670,577, filed Jul. 11, 2012. The present application also incorporates by reference, for all purposes, U.S. patent application Ser. No. 13/760,014, filed Feb. 5, 2013.

### BACKGROUND OF THE INVENTION

The present invention is directed to applications of integrated circuit (IC) and MEMS (Micro-Electro-Mechanical-Systems) devices. More specifically, embodiments of the invention provide methods for improving calibration techniques for integrated MEMS devices and related structures, which can be implemented in mobile phones, tablets, hand-held computers, and the like. But it will be recognized that the invention has a much broader range of applicability.

Research and development in integrated microelectronics have continued to produce astounding progress in CMOS and MEMS. CMOS technology has become the predominant fabrication technology for integrated circuits (IC). MEMS, however, continues to rely upon conventional process technologies. In layman's terms, microelectronic ICs are the “brains” of an integrated device which provides decision-making capabilities, whereas MEMS are the “eyes” and “arms” that provide the ability to sense and control the environment. Some examples of the widespread application of these technologies are the switches in radio frequency (RF) antenna systems, such as those in the iPhone™ device by Apple, Inc. of Cupertino, Calif., and the Blackberry™ phone by Blackberry of Waterloo, Ontario, Canada, and accelerometers in sensor-equipped game devices, such as those in the Wii™ controller manufactured by Nintendo Company Limited of Japan. Though they are not always easily identifiable, these technologies are becoming ever more prevalent in society every day.

Beyond consumer electronics, use of IC and MEMS has limitless applications through modular measurement devices such as accelerometers, gyroscopes, actuators, and sensors. In conventional vehicles, accelerometers and gyroscopes are used to deploy airbags and trigger dynamic stability control functions, respectively. MEMS gyroscopes can also be used for image stabilization systems in video and still cameras, and automatic steering systems in airplanes and torpedoes. Biological MEMS (Bio-MEMS) implement biosensors and chemical sensors for Lab-On-Chip applications, which integrate one or more laboratory functions on a single millimeter-sized chip only. Other applications include Internet and telephone networks, security and financial applications, and health care and medical systems. As described previously, ICs and MEMS can be used to practically engage in various type of environmental interaction.

Although highly successful, ICs and in particular MEMS still have limitations. Similar to IC development, MEMS development, which focuses on increasing performance, reducing size, and decreasing cost, continues to be challenging. Additionally, applications of MEMS often require increasingly complex microsystems that desire greater computational power. Unfortunately, such applications generally do not exist. These and other limitations of conventional MEMS and ICs may be further described throughout the present specification and more particularly below.

From the above, it is seen that techniques for improving operation of integrated circuit devices and MEMS are highly desired.

### BRIEF SUMMARY OF THE INVENTION

The present invention is directed to applications of integrated circuit (IC) and MEMS (Micro-Electro-Mechanical-Systems) devices. More specifically, embodiments of the invention provide methods for improving calibration techniques for integrated MEMS devices and related structures, which can be implemented in mobile phones, tablets, hand-held computers, and the like. Merely by way of example, the MEMS devices can include at least one or more of an accelerometer, a gyroscope, a magnetic sensor, a pressure sensor, a microphone, a humidity sensor, a temperature sensor, a chemical sensor, a biosensor, an inertial sensor, and others. But it will be recognized that the invention has a much broader range of applicability.

Inertial sensors, such as Accelerometers, should ideally sense the parameters of interest (Acceleration (also known as “specific force”) in the case of Accelerometers) with no offset that would impair the acceleration measurement. However, several factors that include design aspects of accelerometers and their susceptibility to offset as a result of package and environmental stress conditions can result in non-zero offsets in accelerometers. Inertial sensor offsets also exhibit dependency on Temperature (T). One specification of interest is the Temperature Coefficient of Offset (TCO), which defines variation of offset/degrees Celsius.

Embodiments of the present invention provide approaches to calibrate the offset of an inertial sensor at certain temperatures and methods of computing the TCO of the inertial sensor based on single or multiple points of measurement. These methods can collectively be referred to as a Dynamic Temperature Calibration (DTC) method. During measurement, sufficient constraints can be placed on offsets of the X, Y, and Z axes. As an example, one constraint can be Xoff, Yoff<<Zoff, where Xoff, Yoff, and Zoff are offsets in measurement of acceleration in X, Y, and Z axes, respectively.

We can choose a time interval when the accelerometer component (device under test (DUT)/calibration) is not undergoing dynamic acceleration. The DUT can be subjected to static acceleration. For example, the static acceleration component from the Earth's gravity can be used for calibrating the accelerometer offset in some embodiments of the present invention. It is not necessary that the part be in any particular position (e.g. horizontal position) for the single point measurement or calibration. However, calibrating in certain positions can benefit in terms of accuracy of calibration.

Whether the DUT is in dynamic acceleration or not can be determined by monitoring existing X, Y, and Z sensor outputs and ensuring that there is no change in these 3 axes data at consecutive time domain data measurements. In an embodiment, the present method can include that a temperature sensor is available as part of the sensor system to detect different temperature measurements measured over time.

Many benefits are achieved by the way of the present invention over conventional techniques. From a user perspective, the DTC implementation can improve measurements to support high performance applications. This implementation can also address sensor offset issues due to temperature variations. A DTC process can be intentionally triggered by the user, or it can run in the background. This allows flexibility for the user or manufacturer of the device to determine what is the best fit with the intended usage and performance requirements. The procedural impact of implementation would be quite low, since many users already expect to calibrate a mobile device's magnetometer via a series of movements to achieve peak accuracy. The DTC process can also run in background where it will not need user to trigger calibration. The DTC can “auto-detect” when the calibration conditions are met. Additionally, this process can be made to consume very low power, as only an initial calibration routine and then a very low duty cycle maintenance task can be used to improve accuracy over time. Further, the calibration conditions can be modified during use to achieve an acceptable combination of quickness in initial convergence and ultimate accuracy. From a developer perspective, this implementation in a device can result in lower cost, since no elaborate in-factory calibration is required. This would eliminate the need for putting each part in a known orientation and taking measurements. The device can work regardless of any source or cause of biases.

Various additional objects, features and advantages of the present invention can be more fully appreciated with reference to the detailed description and accompanying drawings that follow.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 is a simplified flow diagram of a method for calibrating an integrated MEMS device according to an embodiment of the present invention.

FIG. 2 is a simplified flow diagram of a method for calibrating an integrated MEMS device according to an embodiment of the present invention.

FIG. 3 illustrates a simplified functional block diagram of various embodiments of the present invention.

### DETAILED DESCRIPTION OF THE INVENTION

The present invention is directed to applications of integrated circuit (IC) and MEMS (Micro-Electro-Mechanical-Systems) devices. More specifically, embodiments of the invention provide methods and structures for improving calibration techniques for integrated MEMS devices, which can be implemented in mobile phones, tablets, hand-held computers, and the like. Merely by way of example, the MEMS devices can include at least an accelerometer, a gyroscope, a magnetic sensor, a pressure sensor, a microphone, a humidity sensor, a temperature sensor, a chemical sensor, a biosensor, an inertial sensor, and others. But it will be recognized that the invention has a much broader range of applicability.

Inertial sensors, such as Accelerometers, should ideally sense the parameters of interest (Acceleration (also known as “specific force”) in the case of Accelerometers) with no offset that would impair the acceleration measurement. However, several factors that include design aspects of accelerometers and their susceptibility to offset as a result of package and environmental stress conditions can result in non-zero offsets in accelerometers. Inertial sensor offsets also exhibit dependency on Temperature (T). One specification of interest is the Temperature Coefficient of Offset (TCO), which defines variation of offset/degrees Celsius.

Embodiments of the present invention provide approaches to calibrate the offset of an inertial sensor at certain temperatures and methods of computing the TCO of the inertial sensor based on single or multiple points of measurement. During measurement, sufficient constraints can be placed on offsets of the X, Y, and Z axes. As an example, one constraint can be Xoff, Yoff<<Zoff, where Xoff, Yoff, and Zoff are offsets in measurement of acceleration in X, Y, and Z axes, respectively.

We can choose a time interval when the accelerometer component (device under test (DUT)/calibration) is not undergoing dynamic acceleration. The DUT can be subjected to static acceleration. For example, the static acceleration component from the Earth's gravity can be used for calibrating the accelerometer offset in some embodiments of the present invention. It is not necessary that the part be in any particular position (e.g. horizontal position) for the single point measurement or calibration. However, calibrating in certain positions can benefit in terms of accuracy of calibration.

Whether the DUT is in dynamic acceleration or not can be determined by monitoring existing X, Y, and Z sensor outputs and ensuring that there is no change in these 3 axes data at consecutive time domain data measurements.

In an embodiment, the present invention includes a microprocessor, microcontroller or computer implemented method for processing data from an integrated MEMS device disposed within a hand-held computer system programmed to perform the method. Calibration of sensor parameters, such as an accelerometer, and post-processing can be possible during normal operation. We can choose a time interval when there is no dynamic acceleration, as an inertial sensor/accelerometer can sense when it is stationary regardless of orientation (e.g. it is not necessary that the device be in any particular position, such as horizontal, vertical, etc.). This static acceleration can be used for a Dynamic Temperature Calibration (DTC) or Dynamic Temperature Correction (DTC) process.

The calibration can include monitoring existing X, Y, Z sensor outputs and ensuring that there is no change in these 3 axes data at consecutive time domain data measurements. An offset calibration can be calculated using multiple measurements, which can be obtained dynamically during normal operation. In a specific embodiment, gravity will be the only force measured. Measuring gravity in at least four significantly different directions, and the X, Y, Z offsets on the force sensor can be estimated.

Temperature and Offset Calibration Using Multiple Measurements—The present invention provides methods and structures for improving calibration techniques for inertial sensors. According to various embodiments of the present invention, the implementation of a Dynamic Temperature Calibration (DTC) method for inertial sensors can be summarized as follows:

Select X, Y, and Z perturbation/acceleration vectors (measurement points), where ‘position’ of the device is changed, implying ‘static’ acceleration is different, but having no dynamic acceleration. This can be determined using a state machine in hardware or software.

Let Xₘᵢ, Yₘᵢ, and Zₘᵢ be the measurement accelerations at time instance i. Let X_{off}, Y_{off}, and Z_{off} be the offsets on each of the 3 axes respectively at a certain temperature T₀. For example, T₀ may be chosen as room temperature where the devices are originally calibrated for offset (equivalent to ‘Final Test” (FT) test for accelerometers). Let Xₐᵢ, Yₐᵢ, and Zₐᵢ be the actual perturbation/acceleration, when the offsets on each axes is zero. Then,

Xₘᵢ=Xₐᵢ+X_{off}+T_{Cx}(Tᵢ−T₀) (1)

Yₘᵢ=Yₐᵢ+Y_{off}+T_{Cy}(Tᵢ−T₀) (2)

Zₘᵢ=Zₐᵢ+Z_{off}+T_{Cz}(Tᵢ−T₀) (3)

Let ΔT=Tᵢ−T₀ (4)

We know that in absence of dynamic acceleration,

Xₐᵢ²+Yₐᵢ²+Zₐᵢ²=1g² (5)

If we consider two uncorrelated data samples during static perturbation/acceleration (only perturbation/acceleration due to gravity) then,

Xₐ₁²+Yₐ₁²+Zₐ₁²=1g² (6)

At temperature T₀, the temperature sensor reading is saved in a register (OTP). The absolute reading from the temperature sensor is not necessarily required. The temperature sensor shows a certain measurement result at time instance I, which is at the temperature when Xᵢ, Yᵢ, and Z, measurements are made. The different in temperature between T₀ and Tᵢ, which is ΔTᵢ, is of interest in the above equations and can easily be obtained with a well characterized temperature sensor. Knowing T₁−T₀, there are six unknowns in the equation: three are offsets on the X, Y, and Z axes, and the remaining three are temperature coefficients of offset for the X, Y, and Z axes. Combining equations (1) to (5) implies,

(Xₘ₁−X_{off}−T_{Cx}*ΔT₁)²+(Yₘₗ−Y_{off}−T_{Cy}*ΔT₁)²+(Zₘₗ−Z_{off}−T_{Cz}*ΔT₁)²=1g² (7)

If the offsets of the sensor do not change from the programmed value at final test (FT), then, with data from equations (1) to (7), the temperature coefficients can be calculated. However, if there are SMT and stress based offsets that change the offset of the part compared to the one that has been programmed at FT, then data needs to be gathered as follows.

Using a Dynamic Offset Calibration or Dynamic Offset Correction (DOC) method at the first temperature (T₁) with three measurements at different positions, the values of Xoff, Yoff, and Zoff can be calculated at temperature T₁. The calibrated offsets will also calibrate the temperature induced offset. Then after applying the estimated offset correction from the DOC,

X_{m′i}=Xₐᵢ+X_{off} (8)

Y_{m′i}=Yₐᵢ+Y_{off} (9)

Z_{m′i}=Zₐᵢ−Z_{off} (10)

Using equations (7)-(10) implies at another temperature T₂,

(X_{m′1}−T_{Cx}*ΔT₂)²+(Y_{m′1}−T_{Cy}*ΔT₂)²)+(Z_{m′1}−T_{Cx}*ΔT₂)²=1g² (11)

For another independent (uncorrelated) data point at the same temperature T₂,

Xₐ₂²+Yₐ₂²+Zₐ₂²=1g² (12)

(X_{m′2}−T_{Cx}*ΔT₂)²(+(Y_{m′1}−T_{Cy}*ΔT₂)²(+(Z_{m′1}−T_{Cz}*ΔT₂)²=1g² (13)

Subtracting (13) from (11),

(X_{m′1}²−X_{m′2}²)−2*T_{Cx}(X_{m′1}−X_{m′2})+(Y_{m′1}²−Y_{m′2}²)−2*T_{Cy}(Y_{m′1}−Y_{m′2})+(Z_{m′1}²−Z_{m′2}²)−2*T_{Cz}(Z_{m′1}−Z_{m′2})=0 (14)

Once the values of T_{Cx}, T_{Cy}, and T_{Cz} are calculated based on the above approach, then the dynamic calibration may be switched off. The temperature sensor will continue providing ΔTᵢ in real time. A software driver can use T_{Cx}, T_{Cy}, and T_{Cz} values as calculated above and apply that to every measurement so that the offset component related to the temperature coefficient of offset can be substantially eliminated. On the other hand, if the TCO also changes over time, then the DTC will continue providing updated values of T_{Cx}, T_{Cy}, and T_{Cz}.

Simple Algorithm Given Stable Offsets Over Time—If the offsets are stable over time a simplified embodiment of the present method can be used. This embodiment uses an assumption that the ‘offset’ of the device does not substantially change over time or due to environmental conditions. In this case, the DOC process performed at two different temperatures will show a difference in offset, which can be attributed purely to the TCO portion.

Knowing offsets at two different temperatures and knowing the measured temperature values from the temperature sensor, the TCO for each axis can be calculated as,

T_{Cx}=(X_{off}_{_{—}}_{T1}−X_{off}_{_{—}}_{T2})/(T₁−T₂) (15)

X_{off}_{T1} and X_{off}_{_{—}}_{T2} can be obtained by performing a DOC process at two (different) arbitrary temperatures T₁ and T₂. The values for T₁ and T₂ are provided by the temperature sensor. This offset can then be subtracted from each measured data after the initial temperature calibration is complete.

In some embodiments, having uncorrelated pairs of data is needed since the three unknowns can be solved, which implies having some motion or change of state on the part or device. The temperature calibration would require triggering calibration at two different temperatures (e.g. T₁, T₂ different than T₀). This can easily be controlled in hardware by a circuit that detects a required delta in temperature from T₀ and then initiates calibration. In another case, a software driver can poll the temperature sensor, measure temperatures points, and compare T₀ (and T₁ when the measurement is made at T₂), and device when a temperature calibration can be initiated. This, it turn, would require that once the appropriate delta in temperatures is detected, three or more perturbation/acceleration points can be processed to come up with the temperature coefficients T_{Cx}, T_{Cy}, and T_{Cz}. According to some embodiments, averaging the TCO (T_{Cx}, T_{Cy}, and T_{Cz}) over time will lead to more accurate offset numbers.

While computing the offsets, if dynamic acceleration events happen, these events can be detected based on large changes in X, Y, or Z directions and those data points should not be used in the above computation. For example, a hand motion type calibration technique (e.g., used for e-compass calibration on cell phones) can be used. At 256 Hz polling rate, the calibration requires only a few milli-seconds.

Implementation of a Single Point Dynamic Temperature Calibration (SPDTC)—In an embodiment, the present method can include an implementation of a simple approach using a Single Point Dynamic Temperature Calibration or Correction (SPDTC) process. Here, the worst TCO parameter is identified for a single axis (usually Z axis). In the example of where the

Z axis is assumed to have the worst TCO parameter, the X and Y axes are assumed to only account for a certain percentage of the total TCO. ‘Rule-based” heuristics can be applied as a ‘weight’ factor for what percentage of error from temperature gets applied to a certain axis (e.g. apply only 75% of error to Z axis as TCO correction).

From (14),

(X_{m′1}²−X_{m′2}²)−2*T_{Cx}(X_{m′1}−X_{m′2})+(Y_{m′1}²−Y_{m′2}²)−2*T_{Cy}(Y_{m′1}−Y_{m′2})+(Z_{m′1}²−Z_{m′2}²)−2*T_{Cz}(Z_{m′1}−Z_{m′2})=0 (16)

Assuming the TCO budget is distributed as λx to T_{Cx}, λy to T_{Cy}, and λz to Z axis

(X_{m′1}²−X_{m′2}²)−2*λx(X_{m′1}−X_{m′2})+(Y_{m′1}²−Y_{m′2}²)−2*λy(Y_{m′1}−Y_{m′2})+(z_{m′1}²−Z_{m′1}²−Z_{m′2}²)−2*λz(Z_{m′1}−Z_{m′2})=0 (17)

Applying heuristic weights (e.g. λx=0.2λ, λy=0.2λ, λz=0.6λ), equation (17) becomes

(X_{m′1}²−X_{m′2}²)+(Y_{m′1}² −Y_{m′2}²)+(Z_{m′1}²−Z_{m′2}²)=2*0.2λ(X_{m′1}−X_{m′2})+2*0.2(Y_{m′1}−Y_{m′2})+2*0.0.6λ(Z_{m′1}−Z_{m′2}) (19)

Since, Xₘ^{′1}, X_{m′2}, Y_{m′1}, Y_{m′2}, Z_{m′1}², and Z_{m′}₂ are known based on measured data points and estimated offsets, λ and hence λx, λy, and λz can be calculated. With these points known, calibration requires just a single point, which can likely be obtained at power up of the device.

Location of the Temperature Sensor and Effect on Temperature Compensation—In an embodiment, the temperature sensor can be located as part of any of the inertial sensor integrated circuits (IC) or in the same package as the sensors by using multi-chip modules (MCM) (e.g., as in a 6-axis e-compass device).

The power consumption of sensors is typically very small. For accelerometers, the power consumption can be ˜200 uA at 2V implying 0.4 mW of power. There is negligible heating produced due to the accelerometer for a first order calculation. The same can be true in the case of a magnetic sensor or magnetic field sensor (at 300 uA power consumption).

A big thermal source is ambient temperature and due to heating produced by other components on the PCB such as the processor and the like. All these heat sources will radiate heat to the chip containing the temperature sensor approximately the same way as the sensor, which is in the same package even if the temperature sensor is not exactly co-located next to the temperature sensor on the same chip. As far as the higher level system is concerned, the temperature sensor being in the same physical package as an accelerometer (e.g., as in a 6-axis MARS) is co-located.

In some embodiments, correcting for TCO of less than 5 degrees is not necessary. Such values of TCO will cause an offset of 5-10 mg in acceleration, which the system is able to tolerate in some cases. But when the temperature changes by a large amount (e.g., 10-40 degrees), a DTC process can be applied.

In a specific embodiment, if a DOC process is continuously used, then it will calibrate for both static offsets as well as the offset component due to temperature (TCO). However, if continuous usage of DOC is not possible for reasons such as power consumption, then the DTC process can address the problem. With DTC, one can compute (e.g., using software drivers) the TCO for each axis of an inertial sensor once in real time (which is specific to every device part) and then use that on a continuous basis to correct for that TCO of the inertial sensor and any other sensor. The DOC or DTC does not need to be running continuously, as the temperature correction will be accomplished in the software driver once the TCO for each axis is calculated.

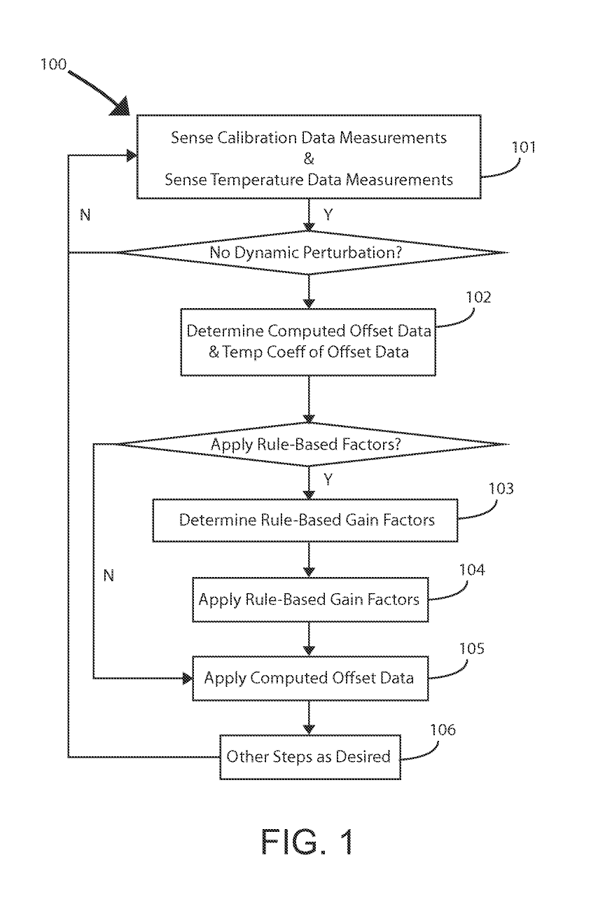

FIG. 1 is a simplified flow diagram of a method for calibrating an integrated MEMS device according to an embodiment of the present invention. In an embodiment, the present invention can include a micro-processor, on-chip logic, or software implemented method for processing data from a MEMS sensor disposed within a hand-held computer system programmed to perform the method. As shown, the method 100 can include the following steps:

101. Sense, by the MEMS sensor and temperature sensor disposed within the computer system, one or more calibration data measurement and one or more temperature data measurements, wherein the sensing of the single calibration data measurement point comprises sensing a set of X, Y, and Z axis sensor data in one static orientation without dynamic perturbation for a predetermined time period;

102. Determine, with a processor disposed within the computer system, computed offset data for the MEMS sensor through a Dynamic Temperature Correction (DTC) process using the one or more calibration data measurements and the one or more temperature data measurements, wherein the DTC process includes determining Temperature Coefficient of Offset (TCO) values for the X, Y, and Z axis of the sensor with a Dynamic Offset Correction (DOC) process;

103. Determine rule-based empirical gain factors using the single calibration data measurement point;

104. Apply the rule-based empirical gain factors to the computed offset data;

105. Apply the computed offset data to the X, Y, or Z axis of the MEMS sensor; and

106. Other steps as desired.

These steps are merely examples and should not unduly limit the scope of the claims herein. One of ordinary skill in the art would recognize many other variations, modifications, and alternatives. For example, various steps outlined above may be added, removed, modified, rearranged, repeated, and/or overlapped, as contemplated within the scope of the invention.

In various embodiment, the present invention can include a microprocessor-implemented method for processing data from an integrated MEMS device disposed within a hand-held computer system programmed to perform the method. The following describes an embodiment of an enhanced dynamic offset correction or calibration (DTC) process. Calibration of sensor parameters, such as an accelerometer, and post-processing can be possible during normal operation. We can choose a time interval when there is no dynamic acceleration, as an accelerometer can sense when it is stationary regardless of orientation (e.g. it is not necessary that the device be in any particular position, such as horizontal, vertical, etc.). This static acceleration can be used for a DTC process.

The calibration can include monitoring existing X, Y, Z sensor outputs and ensuring that there is no change in these 3 axes data at consecutive time domain data measurements. An offset calibration can be calculated using multiple measurements, which can be obtained dynamically during normal operation. In a specific embodiment, gravity will be the only force measured. Using earth's gravity as a reference and measuring acceleration in at least four significantly different orientations of the device, we can estimate X, Y, Z offsets.

In an embodiment, X, Y, Z acceleration vectors (“measurement points”) can be selected where the ‘position’ of the device is changed, implying ‘static’ acceleration in the X, Y, Z axes is different, but without dynamic acceleration, i.e where gravity is the dominant acceleration component being sensed by the device. This can be determined using state machines in hardware or software.

The calibration may be started right at power up. Averaging the X_{off}, Y_{off}, and Z_{off} over time can lead to more accurate offset numbers. In some embodiments, while computing the offsets, if dynamic acceleration event happens it can be detected based on large changes in X, Y, or Z and that data point should not be used in the above computation. This calibration method can be tailored to function efficiently for various sensor data rates. For example, at a 256 Hz or higher polling rate, the calibration can require only a few milli-seconds per measurement point, leading to adequate calibration in significantly less than one second. Conversely, slower data rates can also be used over larger spans of time to achieve very high accuracy offset estimates.

In a specific embodiment, the integrated MEMS device can include a 6-axis inertial sensor with a 3-axis gyroscope and a 3-axis accelerometer or a 3 axis accelerometer and 3 axis magnetometer. During a hand motion calibration (e.g. figure eight) for the gyroscope, the accelerometer can also be gathering data points for calibration or other processes. Other types of user-initiated calibration processes will be recognized by those of ordinary skill in the art.

In an alternative embodiment, a simple approach can be described as follows.

1. Read X, Y, Z. When there is no dynamic acceleration (the part is not moving), X²+Y²+Z²=1g² independent of orientation. Any delta with respect to l g is due to offsets of the 3 axes of the sensor and measurement path.

2. In a simple correction, if we assume that the Z-offset is the worst offset (does not necessarily mean it is the largest for all parts), we can apply the delta to Z while post-processing the Z-axis measurement.

Many benefits are achieved by the way of the present invention over conventional techniques. From a user perspective, the DTC implementation can improve measurements to support high performance applications. This implementation can also address sensor offset issues due to temperature variations. A DTC process can be intentionally triggered by the user, or it can run in the background. This allows flexibility for the user or manufacturer of the device to determine what is the best fit with the intended usage and performance requirements. The procedural impact of implementation would be quite low, since many users already expect to calibrate a mobile device's magnetometer via a series of movements to achieve peak accuracy. The DTC process can also “auto-detect” when the calibration conditions are met. Additionally, this process can consume very low power, as only an initial calibration routine and then a very low duty cycle maintenance task can be used to improve accuracy over time. From a developer perspective, this implementation in a device can result in lower cost, since no elaborate in-factory calibration is required. This would eliminate the need for putting each part in a known orientation and taking measurements. The device can work regardless of any source or cause of biases.

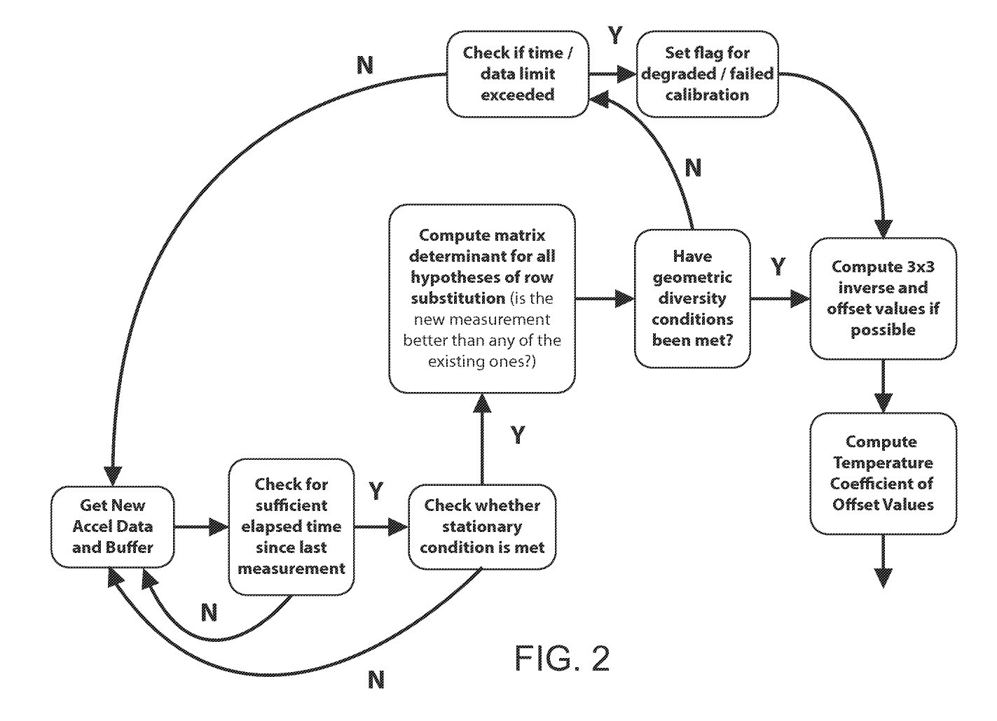

FIG. 2 is a simplified flow diagram of a method for calibrating an integrated MEMS device according to an embodiment of the present invention. This processing flow diagram shows an example of the DOC process discussed previously. In a specific embodiment, the DOC process is used to compute a 3×3 matrix inverse and offset values. This is done by collecting data measurements from the MEMS sensor, in this case a MEMS accelerometer, under various check conditions.

These check conditions include, but are not limited to, whether sufficient time has elapsed since the last measurement, whether a stationary condition of the sensor is met, whether geometric diversity conditions of the collected data are met, whether temperature of the device has remained sufficiently stable, and whether a time/data limit is exceeded. In this embodiment, if the time condition for creating a new measurement point is met, then the stationary check is run. If the stationary check condition is met, then matrix determinants for all hypotheses of row substitutions are computed. This is to determine whether the new measurement is better than any of the existing ones, and to make the substitution as appropriate.

Following the computation of the matrix, if the geometric diversity condition is met, then the 3×3 matrix inverse and offset and TCO values are computed. If not, then the time/data limit condition is checked. If the time condition, stationary condition, or time/data limit conditions are not met, then new data is gathered. If the time/data limit condition is met, then a flag for degradation or failed calibration is set. Alternatively, the processing can be allowed to run until calibration conditions are fully met. Other combinations, variations, modifications, and alternatives in this control logic exist.

The calibration may be started right at power up. Averaging the X_{off}, Y_{off}, and Z_{off} over time can lead to more accurate offset numbers. In some embodiments, while computing the offsets, if dynamic acceleration event happens it can be detected based on large changes in X, Y, or Z and that data point should not be used in the above computation. This calibration method can be tailored to function efficiently for various sensor data rates. For example, at a 256 Hz or higher polling rate, the calibration can require only a few milli-seconds per measurement point, leading to adequate calibration in significantly less than one second. Conversely, slower data rates can also be used over larger spans of time to achieve very high accuracy offset estimates.

In various embodiments, a hand motion type calibration technique (used for e-compass calibration on cell phones) can also be used. Such hand motion type calibration techniques can include a figure eight motion, or other like motions. Another specific method is to hold the device in multiple (e.g four) near orthogonal positions for a short period of time (for example few second or smaller).

In a specific embodiment, the integrated MEMS device can include a 6-axis inertial sensor with a 3-axis gyroscope and a 3-axis accelerometer or a 3 axis accelerometer and 3 axis magnetometer. During a hand motion calibration (e.g. figure eight) for the gyroscope, the accelerometer can also be gathering data points for calibration or other processes. Other types of user-initiated calibration processes will be recognized by those of ordinary skill in the art.

In an alternative embodiment, a simple approach can be described as follows.

1. Read X, Y, Z. When there is no dynamic acceleration (the part is not moving), X²+Y²+Z²=1g² independent of orientation. Any delta with respect to 1g is due to offsets of the 3 axes of the sensor and measurement path.

2. In a simple correction, if we assume that the Z-offset is the worst offset (does not necessarily mean it is the largest for all parts), we can apply the delta to Z while post-processing the Z-axis measurement.

Many benefits are achieved by the way of the present invention over conventional techniques. From a user perspective, the DOC implementation can improve measurements to support high performance applications. A DOC process can be intentionally triggered by the user, or it can run in the background. This allows flexibility for the user or manufacturer of the device to determine what is the best fit with the intended usage and performance requirements. The procedural impact of implementation would be quite low, since many users already expect to calibrate a mobile device's magnetometer via a series of movements to achieve peak accuracy. The DOC process can also “auto-detect” when the calibration conditions are met. Additionally, this process can consume very low power, as only an initial calibration routine and then a very low duty cycle maintenance task can be used to improve accuracy over time. From a developer perspective, this implementation in a device can result in lower cost, since no elaborate in-factory calibration is required. This would eliminate the need for putting each part in a known orientation and taking measurements. The device can work regardless of any source or cause of biases.

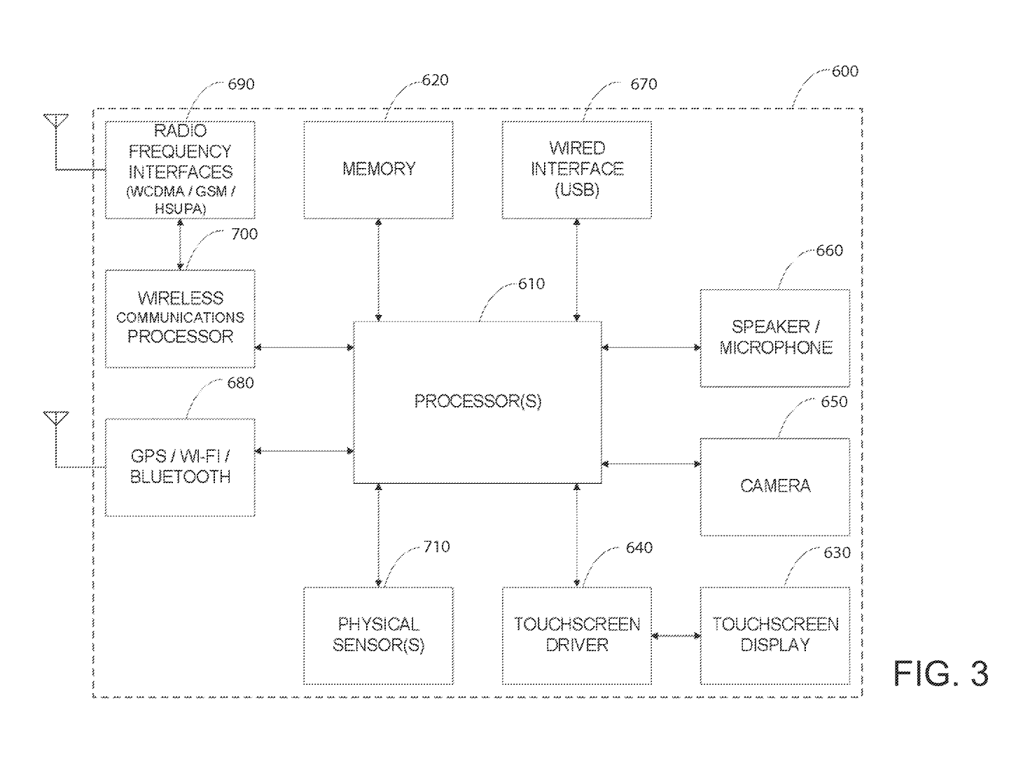

FIG. 3 illustrates a functional block diagram of various embodiments of the present invention. In FIG. 3, a computing device 600 typically includes an applications processor 610, memory 620, a touch screen display 630 and driver 640, an image acquisition device 650, audio input/output devices 660, and the like. Additional communications from and to computing device are typically provided by via a wired interface 670, a GPS/Wi-Fi/Bluetooth interface 680, RF interfaces 690 and driver 700, and the like. Also included in various embodiments are physical sensors 710.

In various embodiments, computing device 600 may be a hand-held computing device (e.g. Apple iPad, Apple iTouch, Dell Mini slate, Lenovo Skylight/IdeaPad, Asus EEE series, Microsoft Courier, Notion Ink Adam), a portable telephone (e.g. Apple iPhone, Motorola Droid, Google Nexus One, HTC Incredible/EVO 4G, Palm Pre series, Nokia N900), a portable computer (e.g. netbook, laptop), a media player (e.g. Microsoft Zune, Apple iPod), a reading device (e.g. Amazon Kindle, Barnes and Noble Nook), or the like.

Typically, computing device 600 may include one or more processors 610. Such processors 610 may also be termed application processors, and may include a processor core, a video/graphics core, and other cores. Processors 610 may be a processor from Apple (A4), Intel (Atom), NVidia (Tegra 2), Marvell (Armada), Qualcomm (Snapdragon), Samsung, TI (OMAP), or the like. In various embodiments, the processor core may be an Intel processor, an ARM

Holdings processor such as the Cortex-A, -M, -R or ARM series processors, or the like. Further, in various embodiments, the video/graphics core may be an Imagination Technologies processor PowerVR -SGX, -MBX, -VGX graphics, an Nvidia graphics processor (e.g. GeForce), or the like. Other processing capability may include audio processors, interface controllers, and the like. It is contemplated that other existing and/or later-developed processors may be used in various embodiments of the present invention.

In various embodiments, memory 620 may include different types of memory (including memory controllers), such as flash memory (e.g. NOR, NAND), pseudo SRAM, DDR SDRAM, or the like. Memory 620 may be fixed within computing device 600 or removable (e.g. SD, SDHC, MMC, MINI SD, MICRO SD, CF, SIM). The above are examples of computer readable tangible media that may be used to store embodiments of the present invention, such as computer-executable software code (e.g. firmware, application programs), application data, operating system data or the like. It is contemplated that other existing and/or later-developed memory and memory technology may be used in various embodiments of the present invention.

In various embodiments, touch screen display 630 and driver 640 may be based upon a variety of later-developed or current touch screen technology including resistive displays, capacitive displays, optical sensor displays, electromagnetic resonance, or the like. Additionally, touch screen display 630 may include single touch or multiple-touch sensing capability. Any later-developed or conventional output display technology may be used for the output display, such as TFT-LCD, OLED, Plasma, trans-reflective (Pixel Qi), electronic ink (e.g. electrophoretic, electrowetting, interferometric modulating). In various embodiments, the resolution of such displays and the resolution of such touch sensors may be set based upon engineering or non-engineering factors (e.g. sales, marketing). In some embodiments of the present invention, a display output port, such as an HDMI-based port or DVI-based port may also be included.

In some embodiments of the present invention, image capture device 650 may include a sensor, driver, lens and the like. The sensor may be based upon any later-developed or convention sensor technology, such as CMOS, CCD, or the like. In various embodiments of the present invention, image recognition software programs are provided to process the image data. For example, such software may provide functionality such as: facial recognition, head tracking, camera parameter control, or the like.

In various embodiments, audio input/output 660 may include conventional microphone(s)/speakers. In some embodiments of the present invention, three-wire or four-wire audio connector ports are included to enable the user to use an external audio device such as external speakers, headphones or combination headphone/microphones. In various embodiments, voice processing and/or recognition software may be provided to applications processor 610 to enable the user to operate computing device 600 by stating voice commands. Additionally, a speech engine may be provided in various embodiments to enable computing device 600 to provide audio status messages, audio response messages, or the like.

In various embodiments, wired interface 670 may be used to provide data transfers between computing device 600 and an external source, such as a computer, a remote server, a storage network, another computing device 600, or the like. Such data may include application data, operating system data, firmware, or the like. Embodiments may include any later-developed or conventional physical interface/protocol, such as: USB 2.0, 3.0, micro USB, mini USB, Firewire, Apple iPod connector, Ethernet, POTS, or the like. Additionally, software that enables communications over such networks is typically provided.

In various embodiments, a wireless interface 680 may also be provided to provide wireless data transfers between computing device 600 and external sources, such as computers, storage networks, headphones, microphones, cameras, or the like. As illustrated in FIG. 3, wireless protocols may include Wi-Fi (e.g. IEEE 802.11 a/b/g/n, WiMax), Bluetooth, IR and the like.

GPS receiving capability may also be included in various embodiments of the present invention, however is not required. As illustrated in FIG. 3, GPS functionality is included as part of wireless interface 680 merely for sake of convenience, although in implementation, such functionality is currently performed by circuitry that is distinct from the Wi-Fi circuitry and distinct from the Bluetooth circuitry.

Additional wireless communications may be provided via RF interfaces 690 and drivers 700 in various embodiments. In various embodiments, RF interfaces 690 may support any future-developed or conventional radio frequency communications protocol, such as CDMA-based protocols (e.g. WCDMA), GSM-based protocols, HSUPA-based protocols, or the like. In the embodiments illustrated, driver 700 is illustrated as being distinct from applications processor 610. However, in some embodiments, these functionality are provided upon a single IC package, for example the Marvel PXA330 processor, and the like. It is contemplated that some embodiments of computing device 600 need not include the RF functionality provided by RF interface 690 and driver 700.

FIG. 3 also illustrates computing device 600 to include physical sensors 710. In various embodiments of the present invention, physical sensors 710 can be single axis or multi-axis Micro-Electro-Mechanical Systems (MEMS) based devices being developed by M-cube, the assignee of the present patent application. Physical sensors 710 can include accelerometers, gyroscopes, pressure sensors, magnetic field sensors, bio sensors, and the like. In other embodiments of the present invention, conventional physical sensors 710 from Bosch, STMicroelectronics, Analog Devices, Kionix or the like may be used.

In various embodiments, any number of future developed or current operating systems may be supported, such as iPhone OS (e.g. iOS), WindowsMobile (e.g. 7), Google Android (e.g. 2.2), Symbian, or the like. In various embodiments of the present invention, the operating system may be a multi-threaded multi-tasking operating system. Accordingly, inputs and/or outputs from and to touch screen display 630 and driver 640 and inputs/or outputs to physical sensors 710 may be processed in parallel processing threads. In other embodiments, such events or outputs may be processed serially, or the like. Inputs and outputs from other functional blocks may also be processed in parallel or serially, in other embodiments of the present invention, such as image acquisition device 650 and physical sensors 710.

FIG. 3 is representative of one computing or micro-processing device 600 capable of embodying the present invention. In one embodiment, the DTC can be implanted on chip with sensors instead of using an external processor. The previously described methods of operation can be implemented with on-chip logic or through a micro-processor in the same device or in a separate chip within the hand-held device. It will be readily apparent to one of ordinary skill in the art that many other hardware and software configurations are suitable for use with the present invention. Embodiments of the present invention may include at least some but need not include all of the functional blocks illustrated in FIG. 3. For example, in various embodiments, computing device 600 may lack image acquisition unit 650, or RF interface 690 and/or driver 700, or GPS capability, or the like. Additional functions may also be added to various embodiments of computing device 600, such as a physical keyboard, an additional image acquisition device, a trackball or trackpad, a joystick, or the like. Further, it should be understood that multiple functional blocks may be embodied into a single physical package or device, and various functional blocks may be divided and be performed among separate physical packages or devices.

In an embodiment, the present invention provides a hand-held computer system for processing data from an integrated MEMS device disposed within a hand-held computer system. The system can include a housing, a tangible memory for storing a plurality of executable instructions, an integrated MEMS device including a MEMS sensor and a temperature sensor disposed within the housing, and a processor disposed within the housing and coupled to the tangible memory and the integrated MEMS device. A sense module can be configured to sense via the MEMS sensor and the temperature sensor. A correction module can be configured for determining via the processor results of various computational processes as further described below. An offset data module can be configured to compute offset data via the processor through a dynamic temperature correction (DTC) process, which is further described below. The processor is programmed to perform a plurality of functions by the plurality of executable instructions. In various specific embodiments, these instructions can include:
executable code that programs the processor to sense, by the MEMS sensor disposed within the computer system, calibration data measurements
executable code that programs the processor to determine, with a processor disposed within the computer system, computed offset data for the MEMS sensor through a dynamic offset correction (DOC) process using the calibration data measurements
executable code that programs the processor to determine, with the processor disposed within the computer system, computed offset data for the MEMS sensor through a Dynamic Temperature Correction (DTC) process using the one or more calibration data measurements and the one or more temperature data measurements
executable code that programs the processor to determine, with the processor disposed within the computer system, computed offset data for the MEMS sensor through a Single

Point Dynamic Temperature Correction (SPDTC) process using a single calibration data measurement and the one or more temperature data measurements
executable code that programs the processor to sense, by the MEMS sensor, X, Y, and Z axis sensor data in at least four static orientations for a predetermined time period
executable code that programs the processor to initiate the DOC process in response to a user performing a predetermined maneuver with the hand-held computer system
executable code that programs the processor to initiate the DOC process in response to a user performing, with the hand-held computer system, a motion of the user retrieving the hand-held computer system from a first user position, holding the computer system at a second user position, holding the computer system at a third user position, and then returning the computer system to the first user position
executable code that programs the processor to run the DOC process constantly as a background DOC process until predetermined calibration conditions are met
executable code that programs the processor to run the DOC process constantly as a background DOC process until time period conditions, temperature conditions, stationary conditions, geometric diversity conditions, or data limit conditions are met
executable code that programs the processor to determine self-test based actuation and measurement information
executable code that programs the processor to sense, by the MEMS sensor, user-initiated calibration data measurements as the user places the hand-held computer system on a level surface and presses a button, or as the user performs a FIG. 8 maneuver, and determining, by the processor, user-initiated computed offset data using the user-initiated calibration data measurements

In a specific embodiment, the MEMS sensor can include a MEMS accelerometer, a MEMS gyrometer, or a MEMS inertial sensor, or the like. The integrated MEMS device can include an integrated 6-axis MEMS inertial sensing device including the MEMS accelerometer and a MEMS gyroscope. The integrated MEMS device can also include an integrated 6-axis MEMS inertial sensing device including the MEMS accelerometer and a Magnetometer or an integrated 9-axis or 10-axis inertial sensing device including the MEMS accelerometer and a MEMS gyroscope, a magnetometer, and a pressure sensor. There can be other variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

1. A micro-processor, on-chip logic, or software implemented method for processing data from an integrated MEMS device having an inertial sensor and a temperature sensor disposed within a hand-held computer system programmed to perform the method, the method comprising:
sensing, by the inertial sensor disposed within the computer system, one or more calibration data measurements;
sensing, by the temperature sensor disposed within the computer system, one or more temperature data measurements; and
determining, with a processor disposed within the computer system, computed offset data for the MEMS sensor through a dynamic temperature correction (DTC) process using the calibration data measurements and the temperature data measurements.

2. The method of claim 1 wherein the sensing of the one or more calibration data measurements comprises sensing X, Y, and Z axis sensor data in one or more static orientations for a predetermined time period; and
wherein the sensing of the one or more temperature data measurements comprises sensing a first temperature measurement and a second temperature measurement.

3. The method of claim 2 wherein the DTC process includes determining Temperature Coefficient of Offset (TCO) values for the X, Y, and Z axis of the sensor with a Dynamic Offset Correction (DOC) process using the first and second temperature measurements and the one or more data calibration measurements;
wherein the DOC process includes determining a first calibration offset value related to the first temperature measurement and a second calibration offset value related to the second temperature measurement.

4. The method of claim 3 wherein the determining of the TCO values for the X, Y, and Z axis of the sensor is calculated as: T_{Cx}=(X_{off}_{_{—}}_{T1}−X_{off T2})/(T₁−T₂), where T₁ is the first temperature measurement, T₂ is the second temperature measurement, X_{off}_{_{—}}_{T1} is the first calibration measurement, and X_{off}_{_{—}}_{T2} is the second calibration measurement.

5. The method of claim 1 wherein the DTC process includes determining Temperature Coefficient of Offset (TCO) values using a Dynamic Offset Correction (DOC) process using the one or more temperature data measurements and the one or more calibration data measurements.

6. The method of claim 1 wherein the DTC process is configured as a background DTC process that constantly runs until predetermined calibration conditions are met;
wherein the predetermined calibration conditions include time period conditions, stationary conditions, temperature conditions, geometric diversity conditions, or data limit conditions.

7. The method of claim 6 wherein the conditions of time period, stationary conditions, temperature conditions, geometric diversity conditions, or data limit conditions are modified over time to improve accuracy after an initial period of convergence or completion using less stringent conditions.

8. A micro-processor, on-chip logic, or software implemented method for processing data from a MEMS (Micro-Electro-Mechanical-Systems) sensor and a temperature sensor disposed within a hand-held computer system programmed to perform the method, the method comprising:
sensing, by the MEMS sensor disposed within the computer system, a single calibration data measurement point;
sensing, by the temperature sensor disposed within the computer system, one or more temperature data measurement points; and
determining, with a processor disposed within the computer system, computed offset data for the MEMS sensor through a Single Point Dynamic Temperature Correction (SPDTC) process using the single calibration data measurement point and the one or more temperature data measurement points.

9. The method of claim 8 wherein the sensing of the single calibration data measurement point comprises sensing a set of X, Y, and Z axis sensor data in one static orientation for a predetermined time period.

10. The method of claim 8 wherein the SPDTC process includes determining Temperature Coefficient of Offset (TCO) values using the one or more temperature data measurements and the single calibration data measurements.

11. The method of claim 10 further comprising applying the TCO values to a single axis of the MEMS sensor assumed to have the worst errors.

12. The method of claim 11 wherein the SPDTC process comprises:
determining rule-based empirical gain factors using the single calibration data measurement point and a priori error statistic of an axis of the component; and
applying the rule-based empirical gain factors to the computed offset data and applying the computed offset data to the X, Y, or Z axis of the MEMS sensor.

13. The method of claim 8 wherein the SPDTC process is configured as a background DTC process that constantly runs until predetermined calibration conditions are met;
wherein the predetermined calibration conditions include time period conditions, stationary conditions, or data limit conditions.

14. The method of claim 13 wherein time period conditions, stationary conditions, or data limit conditions are modified over time to improve accuracy after an initial period of convergence or completion using less stringent conditions.

15. The method of claim 8 wherein the DTC process includes determining self-test based actuation and measurement information.

16. A hand-held inertial sensor system for processing data from an integrated MEMS (Micro-Electro-Mechanical-Systems) device disposed within the hand-held inertial sensor system, the system comprising:
a housing;
a tangible memory for storing a plurality of executable instructions;
an integrated MEMS device disposed within the housing, the integrated MEMS device including a MEMS sensor;
a temperature sensor disposed within the housing; and
a processor disposed within the housing and coupled to the tangible memory and the integrated MEMS device and the temperature sensor, wherein the processor is programmed to perform a plurality of functions by the plurality of executable instructions;
wherein the plurality of executable instructions comprises:
executable code that programs the processor to sense, by the MEMS sensor disposed within the computer system, one or more calibration data measurements;
executable code that programs the processor to sense, by the temperature sensor disposed within the computer system, one or more temperature data measurements; and
executable code that programs the processor to determine, with the processor disposed within the computer system, computed offset data for the MEMS sensor through a Dynamic Temperature Correction (DTC) process using the one or more calibration data measurements and the one or more temperature data measurements.

17. The system of claim 16 wherein the executable code that programs the processor to sense the one or more calibration data measurements comprises:
executable code that programs the processor to sense, by the MEMS sensor, a set of X, Y, and Z axis sensor data in one static orientation for a predetermined time period.

18. The system of claim 16 wherein the executable code that programs the processor to determine the computed offset data using the DTC process comprises:
executable code that programs the processor to determine Temperature Coefficient of Offset (TCO) values using a Dynamic Offset Correction (DOC) process using the one or more temperature data measurements and the one or more calibration data measurements.

19. The system of claim 16 wherein the DOC process comprises a Single Point Dynamic Temperature Correction (SPDTC) process and the determining of the computed offset data using the DTC process includes determining the computed offset data using the SPDTC process;
wherein the sensing of the one or more calibration data measurements comprises sensing a single calibration data measurement; and
wherein the executable code that programs the processor to determine the computed offset data using the SPDTC process comprises:
executable code that programs the processor to determine Temperature Coefficient of Offset (TCO) values using a the one or more temperature data measurements and the single calibration data measurement.

20. The system of claim 19 wherein the plurality of executable instructions comprises:
executable code that programs the processor to apply the computed offset data to a single axis of the MEMS sensor assumed to have the worst errors.

21. The system of claim 20 wherein the executable code that programs the processor to determine the computed offset data using the SPDTC process comprises:
executable code that programs the processor to determine rule-based empirical gain factors using the single calibration data measurement point; and
executable code that programs the processor to apply the rule-based empirical factors to the computed offset data and applying the computed offset data to the X, Y, or Z axis of the MEMS sensor.

22. The system of claim 16 wherein the plurality of executable instructions comprise:
executable code that programs the processor to initiate the DTC process in response to a user, developer, or manufacturer command;
executable code that programs the processor to run the DTC process constantly as a background DTC process until time period conditions, stationary conditions, or data limit conditions are met, or
executable code that programs the processor to initiate the DTC process.

23. The system of claim 16 wherein the plurality of executable instructions comprises executable code that programs the processor to determine self-test based actuation and measurement information.
